(19) United States
(12) Patent Application Publication
(10) Pub. No.: US 2015/0382314 A1
(43) Pub. Date: Dec. 31, 2015

(54) A Network Node, a Core Network Node, and Methods Therein

(71) Applicant: TELEFONAKTIEBOLAGET L M ERICSSON (PUBL), Stockholm (SE)

(72) Inventors: Sairamesh Nammi, Kista (SE); Mark Curran, Tullow (IE); Namir Lidian, Solna (SE); Nianshan Shi, Järfälla (SE)

(73) Assignee: Telefonaktiebolaget L M Ericsson (publ), Stockholm (SE)

(21) Appl. No.: 14/768,963

(22) PCT Filed: Jan. 17, 2014
(86) PCT No.: PCT/SE2014/050055

§ 371 Date: Aug. 19, 2015

Related U.S. Application Data
(60) Provisional application No. 61/772,841, filed on Mar. 5, 2013.

(51) Int. Cl. H04W 52/42; H04W 52/38; H04W 52/32

(52) U.S. Cl. CPC H04W 52/42; H04W 52/325; H04W 52/386; H04W 84/045

(57) ABSTRACT

A method in a network node for sending a pilot power value in a heterogeneous mobile communications network. The heterogeneous mobile communications network comprises a second set of base station nodes selected to operate in a Multiple Input Multiple Output, MIMO, -mode. The second set of base station nodes share a cell identity and are deployed within a coverage area. The network node computes (802) a pilot power value to be applicable when one or more mobile devices in the coverage area evaluates receipt of one or more Secondary Common Pilot Channels, S-CPICH, from a transmitter in said second set of base station nodes, wherein the computing is based on a measure indicative of a transmission power of the second set of base stations. The network node sends a signal to a radio network controller. The signal comprises the computed pilot power value, and enables the one or more mobile devices to be configured for MIMO operation.

### TECHNICAL FIELD

Embodiments herein relate to a network node, a core network node in and methods therein in. In particular, the embodiments relate to methods for enabling configuration of mobile devices for Multiple Input Multiple Output operation in a heterogeneous mobile communications network.

### BACKGROUND

Communication devices such as mobile devices are also known as e.g. User Equipments (UE) mobile terminals, wireless terminals and/or mobile stations. User equipments are enabled to communicate wirelessly in a wireless communications network, sometimes also referred to as a wireless communication system, a cellular communications network, a cellular radio system or a cellular network. The communication may be performed e.g. between two user equipments, between a user equipment and a regular telephone and/or between a user equipment and a server via a Radio Access Network (RAN) and possibly one or more core networks, comprised within the cellular communications network.

User equipments may further be referred to as mobile telephones, cellular telephones, laptops, or surf plates with wireless capability, just to mention some further examples. The user equipments in the present context may be, for example, portable, pocket-storable, hand-held, computer-comprised, or vehicle-mounted mobile devices, enabled to communicate voice and/or data, via the RAN, with another entity, such as another user equipment or a server.

The wireless communications network covers a geographical area which is divided into cell areas, wherein each cell area is served by a base station, e.g. a Radio Base Station (RBS), which sometimes may be referred to as e.g. “eNB”, “eNodeB”, “NodeB” or “B node” depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the user equipments within range of the base stations.

In some RANs, several base stations may be connected, e.g. by landlines or microwave, to a radio network controller, e.g. a Radio Network Controller (RNC) in Universal Mobile Telecommunications System (UMTS), and/or to each other. The radio network controller may supervise and coordinate various activities of the plural base stations connected thereto.

During the last few years, cellular network operators have started to offer mobile broadband based on Wideband Code Division Multiple Access (WCDMA) and/or High Speed Packet Access (HSPA). Fuelled by new mobile devices designed for data applications, end user performance requirements have been steadily increasing. The large uptake of mobile broadband has resulted in significant growth in the traffic volumes that need to be handled by the HSPA networks. Therefore, techniques that allow cellular network operators to manage their network resources more efficiently are becoming increasingly important.

Standardized by the third Generation Partnership Project (3GPP), HSPA supports the provision of voice services in combination with mobile broadband data services. HSPA comprises High Speed Downlink Packet Access (HSDPA), High Speed Uplink Packet Access (HSUPA) and HSPA+. HSDPA allows networks based on UMTS to have higher data transfer speeds and capacity. In HSDPA, a new transport layer channel, High Speed Downlink Shared Channel (HS-DSCH), has been added to the UMTS release 5 and further specification. It is implemented by introducing three new physical layer channels: High Speed-Shared Control Channel (HS-SCCH), Uplink High Speed-Dedicated Physical Control Channel (HS-DPCCH) and High Speed-Physical Downlink Shared Channel (HS-PDSCH). The HS-SCCH informs the user equipment, such as a mobile device, that data will be sent on the HS-DSCH, 2 slots ahead. The HS-DPCCH carries acknowledgment information and current Channel Quality Indicator (CQI) of the user equipment. This value is then used by the base station to calculate how much data to send to the user equipments on the next transmission. The HS-PDSCH is the channel mapped to the above HS-DSCH transport channel that carries actual user data.

Traditionally, networks have been arranged in a homogeneous structure, with the network comprising base stations, also known as NodeBs, arranged in a planned layout in which all base stations have similar transmit power levels, antenna patterns, receiver noise floors, and similar backhaul connectivity to the data network. Moreover, all base stations offer unrestricted access to consumer mobile devices (also known as User Equipments—UEs) in the network, and serve roughly the same number of mobile devices. Current wireless systems falling under this category include, for example, Global System for Mobile communications (GSM), WCDMA, HSDPA, Long Term Evolution (LTE) and Worldwide Interoperability for Microwave Access (WiMAX).

More recently, heterogeneous mobile communications network structures have been considered. Heterogeneous networks are an efficient network deployment solution for satisfying the ever-increasing demand of mobile broadband services. In heterogeneous mobile communications networks, in addition to the planned or regular placement of macro base stations, one or more Low Power Nodes (LPN), e.g. pico base stations or femto base stations or relay base stations are deployed as shown in FIG. 1. The low power nodes may be placed in traffic hot spots or coverage holes within the coverage area of the high- or higher-power node, for example a macro base station, which may be a NodeB, to better serve nearby mobile devices. Deploying a low power node in a traffic hot spot may significantly reduce the load in the macro or other higher-power cell covering the area. Due to their lower transmit power and smaller physical size, pico base stations or femto base stations or relay base stations may offer flexible site acquisitions. The power at which the picocell, microcell or femtocell base stations transmit may be of the order of 2 W, which compares to around 40 W for a macro base station.

Two use-cases for heterogeneous mobile communications network deployment envisioned are coverage holes and localized traffic hotspots. Coverage holes may be due to difficult radio environments, such as shielded buildings, etc. or locations where site acquisition is challenging. Localized traffic hotspots are useful in areas of heavy data usage, such as sports events, shopping malls, etc. Deployment of LPNs as a complement to a macro network then aims at improving capacity and coverage. To maximize spectrum usage, it is desirable for the traditional macro NodeB and LPNs to share the same frequency—the so-called co-channel deployment.

To maximize the suitability of a heterogeneous mobile communications network deployment in UMTS for a certain use-case and to boost its efficiency, several issues need to be addressed. Although a good deployment strategy may potentially enhance the performance of an existing UMTS network by readily adding LPNs to it, there exist more opportunities for 3GPP Rel-12 to include value-added features to further improve the performance.

Some techniques that may be used to improve the downlink performance for mobile devices, such as user equipments include 4-branch Multiple Inputs Multiple Outputs (MIMO), multiflow communication, multi carrier deployment, etc. Since improvements in spectral efficiency per link are approaching theoretical limits, the next generation technology is about improving the spectral efficiency per unit area. In other words, the additional features for HSDPA need to provide a uniform user experience to users anywhere inside a cell by changing the topology of traditional networks. Currently 3GPP has been working on this aspect through studies of heterogeneous mobile communications network structures see for example 3GPP RP-121436 “Study on UMTS Heterogeneous Networks”, 3GPP R1-124512 “Initial considerations on Heterogeneous Networks for UMTS” and R1-124513 “Heterogeneous Network Deployment Scenarios”.

As described in “Heterogeneous Network Deployment Scenarios” 3GPP R1-124513, in a shared or combined cell deployment of low power base stations having the same cell identifier as the overlying macro base station and a deployment where the low power base stations and the macro base station use the same frequency, it is possible for a mobile device to only receive data from one or more antennas of a single base station, or to operate such that it receives data from one or more antennas of both a macro base station and one or more low power base stations simultaneously. This latter arrangement may be considered as a distributed MIMO arrangement. The decision of which nodes to use to transmit data to a specific mobile device is made by a central scheduler, or central controller, based on information provided by the UE or based on information from other sources. Mobile devices will also be referred to as UEs herein.

Based on the possibility for there to be data transmission from different nodes, transmission modes in a combined cell deployment may be divided into:
a. Single Frequency Network (SFN): In this mode all nodes, such as base stations, transmit the same pilot channel, and data and control information is transmitted from all the nodes. Note that in this case only one UE may be served from all the nodes at any instant in time. Hence this mode is useful for coverage improvement. Furthermore, this mode works for all legacy UEs, i.e. UEs not complying with the most recent releases of the standards.
b. Node Selection with Spatial Re-use: In this mode, even though all the nodes, such as base stations, transmit the same pilot channel; data and the control information transmitted from one node is different from that from every other or at least one other node. I.e. one or more nodes will be serving a specific UE, while at the same time different data and control channel information will be sent to a different UE. Hence the spatial resources may be reused. This mode provides load balancing gains, which means the capacity of the combined cell may be increased significantly.
c. MIMO mode with spatially separated nodes: In this mode, some of the low power nodes act like a distributed MIMO, i.e. MIMO transmission with spatially separated antennas. In this mode, MIMO gains, both diversity and multiplexing gains, may be achieved, since distributed MIMO provides significant capacity gains better than MIMO transmission with co-located antennas. By using this approach the performance of combined cell may be increased significantly.

In particular, for MIMO capable UEs, there are a number of ways to enable spatial reuse by utilizing existing or new MIMO operations. In principle, the multiple transmit antennas used by a MIMO transmitter may be arranged within a network node of a heterogeneous mobile communications network or distributed to different locations, i.e. distributed across multiple nodes in the heterogeneous mobile communications network.

However, in a heterogeneous mobile communications network also including mobile devices incapable of receiving MIMO transmission, an extensive deployment of multiple transmit antennas causes interference to the legacy mobile devices from a secondary pilot channel. As an effect, increasing the pilot power on a 2^{nd} antenna reduces cell throughput, hence the mean throughput for legacy mobile devices.

### SUMMARY

It is therefore an object of embodiments herein to provide methods and apparatuses that enable MIMO operation with improved performance in a heterogeneous mobile communications network.

According to a first aspect of embodiments herein, the object is achieved by a method in a network node for sending a pilot power value in a heterogeneous mobile communications network. The heterogeneous mobile communications network comprises a second set of base station nodes selected to operate in a Multiple Input Multiple Output, MIMO, -mode. The second set of base station nodes share a cell identity and is deployed within a coverage area.

The network node computes a pilot power value to be applicable when one or more mobile devices in the coverage area evaluates receipt of one or more secondary Secondary Common Pilot Channels, S-CPICH, from a transmitter in said second set of base station nodes. The computing is based on a measure indicative of a transmission power of the second set of base station nodes.

The network node then sends a information to a radio network controller, which information is indicative of the computed pilot power value, enabling the one or more mobile devices to be configured for MIMO operation.

According to a second aspect of embodiments herein, the object is achieved by a network node adapted to send a pilot power value in a heterogeneous mobile communications network. The heterogeneous mobile communications network comprises a second set of base station nodes selected to operate in a Multiple Input Multiple Output, MIMO, -mode. The second set of base station nodes share a cell identity and are deployed within a coverage area. The network node comprises a processing module configured to compute a pilot power value to be applicable when one or more mobile devices in the coverage area evaluates receipt of one or more Secondary Common Pilot Channels, S-CPICH, from a transmitter in said second set of base station nodes. The computing is based on a measure indicative of a transmission power of the second set of base stations.

The processing module is further configured to generate a information to a radio network controller. The information is indicative of the computed pilot power value.

According to a third aspect of embodiments herein, the object is achieved by a method in a radio network controller for enabling at least one mobile device in configuring itself for Multiple Input Multiple Output, MIMO, operation in a heterogeneous mobile communications network. The heterogeneous mobile communications network comprises a second set of base station nodes selected to operate in a MIMO-mode. The second set of base station nodes share a cell identity and are deployed within a coverage area.

The radio network controller receives information from a network node. The information is indicative of a computed pilot power value to be applicable when one or more mobile devices in the coverage area evaluates receipt of one or more Secondary Common Pilot Channels, S-CPICH from a transmitter in said second set of base station nodes.

The radio network controller determines a pilot power offset for the one or more S-CPICHs, based on the received information.

The radio network controller sends a signal to the at least one mobile device within the coverage area, which signal comprises information indicative of said pilot power offset. The signal enables the one or more mobile devices in configuring itself for MIMO operation.

According to a fourth aspect of embodiments herein, the object is achieved by a radio network controller adapted to operate in a heterogeneous mobile communications network comprising a second set of base station nodes selected to operate in a Multiple Input Multiple Output, MIMO, -mode. The second set of base station nodes share a cell identity and are deployed within a coverage area. The radio network controller comprises a processing module configured to receive information indicative of a computed pilot power value to be applicable when one or more mobile devices in the coverage area evaluates receipt of one or more Secondary Common Pilot Channels, S-CPICHs, from a transmitter in said second set of base station nodes. The processing module is further configured to determine a pilot power offset for the one or more S-CPICHs, based on the received information. The processing module is further configured to generate a signal to at least one mobile device within the coverage area comprising information indicative of said pilot power offset.

The network node computes the pilot power value applicable when the one or more mobile devices in the coverage area evaluates receipt of one or more S-CPICHs, based on a measure indicative of a transmission power of the second set of base station nodes and the network node sends the computed pilot power value to the radio network controller. Since the radio network controller sends a pilot power offset for the one or more S-CPICHs based on a measure indicative of a transmission power of the second set of base station nodes the one or more mobile devices are enabled to be configured for MIMO operation in the heterogeneous mobile communications network.

This results in a MIMO operation with an improved performance in the heterogeneous mobile communications network.

An advantage with embodiments herein is that they enable MIMO gains to be achieved, and it is also possible to maintain the coverage and spatial re-use gains associated with known modes of operation of combined cells, whilst limiting the drawbacks of increased interference experienced by legacy mobile devices, i.e. mobile devices which are not capable of MIMO operation.

A further advantage is that mobile devices which are not capable of MIMO operation are less interfered by S-CPICHs.

### BRIEF DESCRIPTION OF THE DRAWINGS

Embodiments of the present disclosure will be more readily understood through the study of the following detailed description of the embodiments, with reference to the following drawings, in which:

FIG. 1 is an illustration of an exemplary heterogeneous mobile communications network;

FIG. 2 is an illustration of a shared or combined cell in a heterogeneous mobile communications network;

FIG. 3 is an illustration of transmissions in a single frequency network (SFN) form of combined cell deployment;

FIG. 4 is an illustration of transmissions in a spatial reuse form of combined cell deployment;

FIG. 5 is an illustration of one way of utilizing a MIMO mode with spatially separated nodes;

FIG. 6 is an illustration of another way of utilizing a MIMO mode with spatially separated nodes;

FIG. 7 is an illustration of embodiments of a heterogeneous mobile communications network;

FIG. 8 is a flow chart of a method embodiment performed in a network node

FIG. 9 is a block diagram of a network node, here illustrated as a NodeB;

FIG. 10 is a flow chart of a method embodiment performed in a radio network controller;

FIG. 11 is a block diagram of a radio network controller;

FIG. 12 is a message sequence chart illustrating messaging between the radio network controller, network nodes and a mobile device.

### DETAILED DESCRIPTION

As part of developing embodiments herein, a problem will first be identified and discussed.

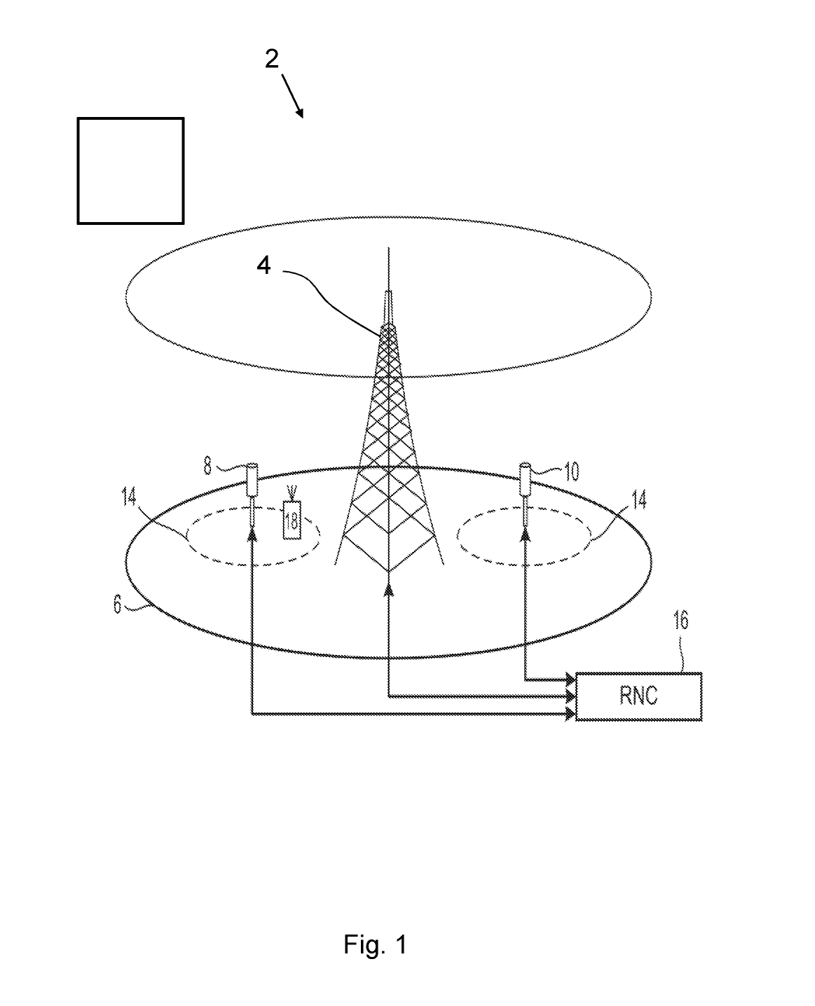

FIG. 1 shows an exemplary heterogeneous UMTS mobile communication network 2 corresponding to prior art. The heterogeneous UMTS mobile communication network 2 may be an UMTS network, that comprises a network node. The network node may for example be a macro node, or a macro base station, such as a macro base station 4. The macro base station 4 may for example be a NodeB. The macro base station 4 establishes a cell with a coverage area 6. Two low power nodes, such as first low power base station 8, and a second low power base station 10, are located within the coverage area 6 of the macro base station 4. The low power base stations 8, 10 may for example be femtocell base stations. Each low power base station 8, 10 define a respective coverage area 12, 14. For example, the first low power base station may define a first coverage area 12, while the second low power base station 10 may define a second coverage area 14.

The base stations 4, 8, 10 are connected to a radio network controller 16 which controls the base stations 4, 8, 10 and manages radio resources and mobility in the cell. The radio network controller 16 may for example be an RNC in an UMTS network. The radio network controller 16 connects to the macro base station 4, and connects via the Internet to the low power base stations 8, 10. The radio network controller 16 also connects the base stations 4, 8, 10 to higher parts of the network 2, such as a Core Network, CN, not shown in FIG. 1.

A mobile device 18 is shown in the coverage area 12 of the low power base station 8 and in the coverage area 6 of the macro base station 4. The mobile device 18 may be a UE.

In some heterogeneous mobile communications network deployments, each of the cells defined by the macro base station 4 and the low power base stations 8, 10 have respective cell identifiers, which means that the macro base station 4 and the low power base stations 8, 10 effectively define different cells. Simulations show that using low power base stations 8, 10 in a macro base station coverage area 6 in this way offers load balancing, which results in large gains in system throughput as well as cell edge throughput for mobile devices. However, a disadvantage with this arrangement is that as each low power base station 8, 10 creates its own cell, it is necessary for the mobile device 18 to perform a soft handover from one low power base station 8, 10 to the macro base station 4 or to another of the low power base stations 8, 10, which means higher layer signaling is required to perform the handover.

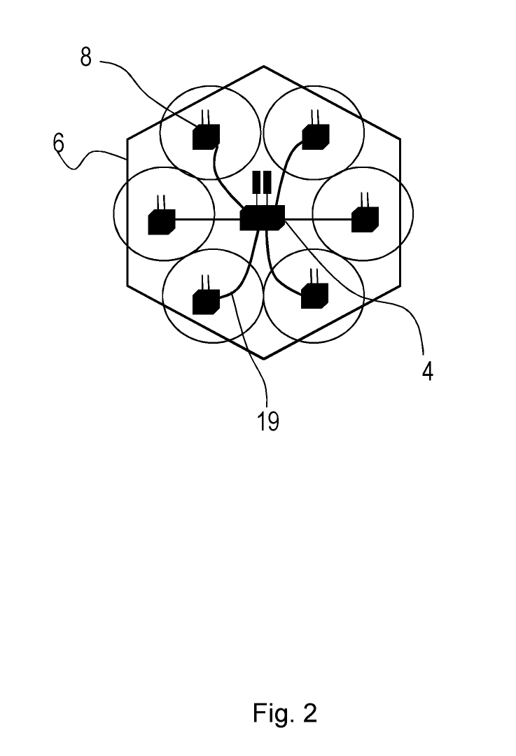

However, in other heterogeneous mobile communications network deployments, each of the low power base stations 8, 10 use the same cell identifier as the macro base station 4, which means that the macro base station 4 and the low power base stations 8, 10 are part of the same cell and effectively ‘assist’ the macro base station 4 in providing service to the mobile device 18. This type of deployment is known as a shared or combined cell, and is generally illustrated in FIG. 2. In a combined cell, all the nodes, i.e. macro base station 4 and low power base stations 8, 10, are connected via high speed links 19, such as optical links. A central scheduler or controller (not shown) is connected to the radio network controller 16 and also to any one of the base stations, usually to the macro base station 4, and takes responsibility for collecting operational statistics information from network environment measurements. This type of deployment avoids the need for the mobile device 18 to perform frequent soft handovers, and thus avoids the need for additional higher layer signaling.

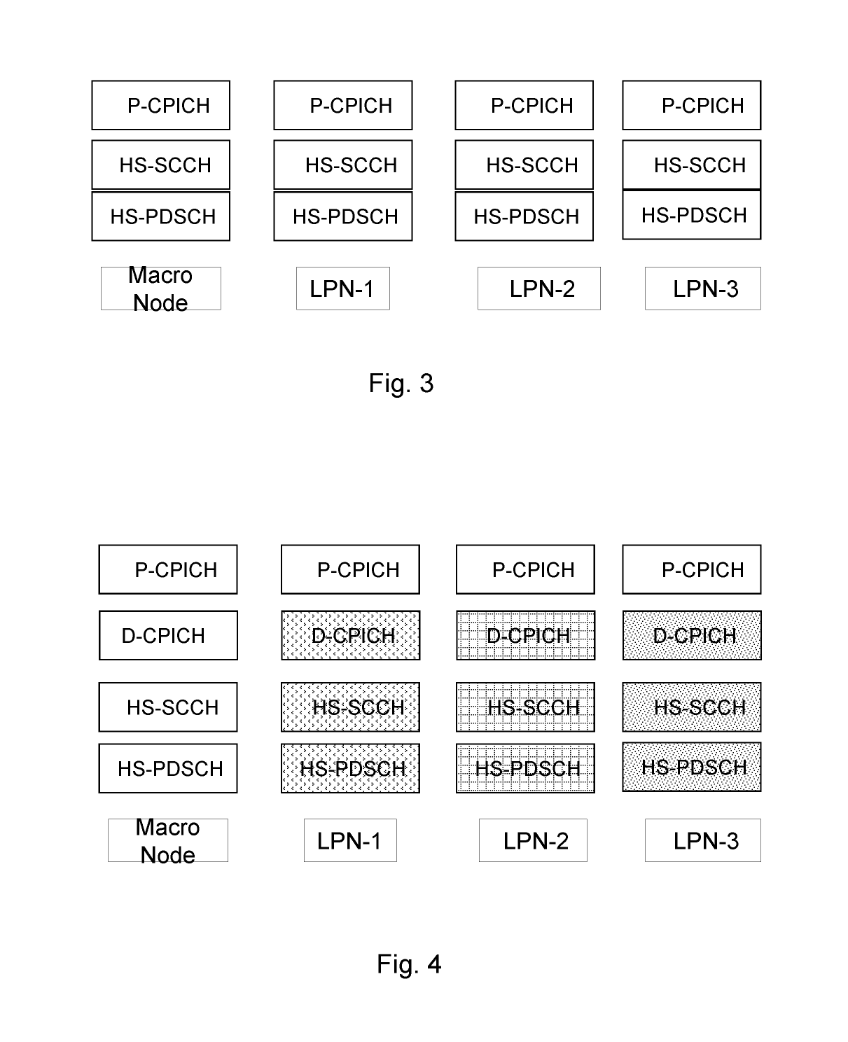

FIG. 3 provides an illustration of the transmissions of various channels in a SFN combined cell deployment. Thus, it may be seen that the HSDPA pilot channel, which is called the Primary Common Pilot Channel (P-CPICH) and the same HS-SCCH and HS-PDSCH are transmitted by each of the nodes in the combined cell deployment, i.e. a macro node, labeled Macro Node, and three low power nodes, labeled LPN-1, LPN-2 and LPN-3. The CQI of the mobile device is computed based on the channel estimates from the P-CPICH.

FIG. 4 provides an illustration of the transmission of various channels in a spatial reuse combined cell deployment. Thus, it may be seen that the nodes, labeled as Macro Node and LPN-1, LPN-2 and LPN-3, each transmit the same P-CPICH. However, each of the nodes transmit respective D-CPICH, HS-SCCH and HS-PDSCH channels which are different from each other.

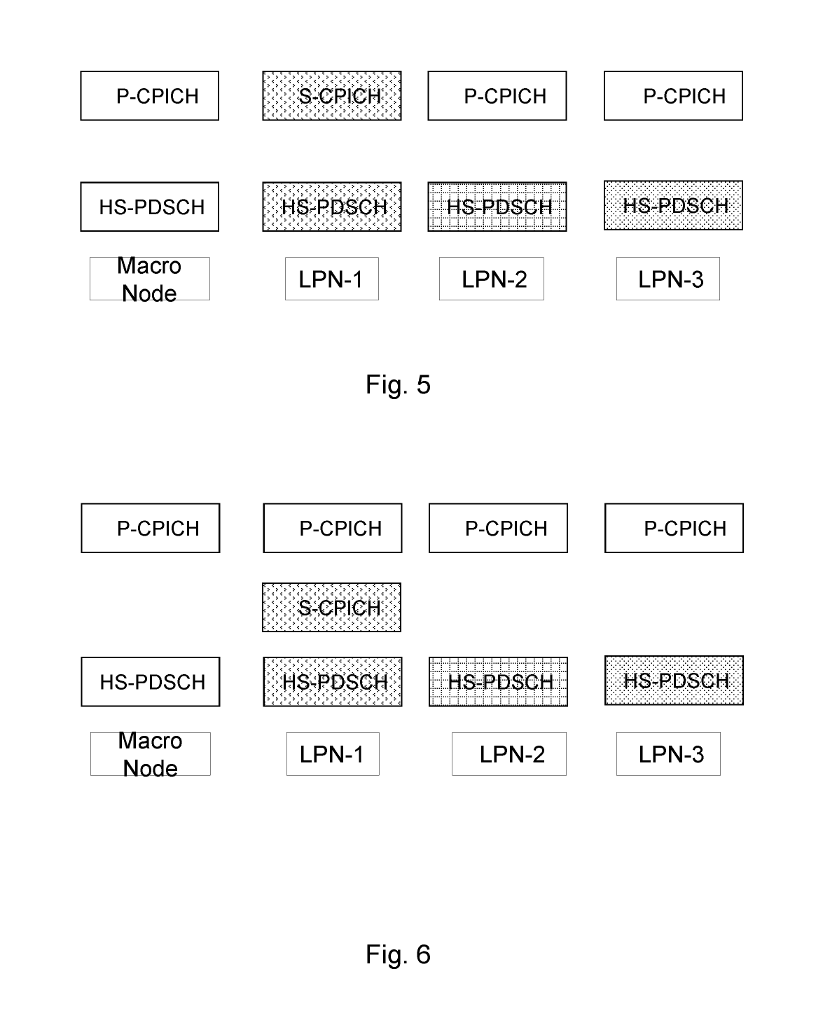

FIGS. 5 and 6 illustrate two ways in which a macro cell base station and low power stations in the combined cell may be operated to implement a MIMO mode with spatially separated nodes. In FIGS. 5 and 6, the macro base station 4 is labeled as ‘macro node’, the low power base station 8 in whose coverage area the MIMO capable mobile device 18, and potentially one or more other MIMO-capable UEs, is located is labeled ‘LPN-1’ and two other low power base stations are shown, which are labeled LPN-2 and LPN-3. As shown in FIG. 5, a key difference in implementing the MIMO mode with spatially separated nodes as compared to the SFN and “node selection with spatial re-use” modes is in the way pilots are configured, and in particular some nodes, i.e. LPN-1 in this case, need to transmit a Secondary Common Pilot CHannel (S-CPICH) rather than the P-CPICH.

In this case, the MIMO-capable UE 18 in the cell portion of LPN-1 sees two spatial channels. The first spatial channel is the channel experienced by P-CPICH, which is a combined channel including all the paths from the macro node, LPN-2 and LPN-3 to the UE 18. The second spatial channel is the one experienced by S-CPICH, which includes only paths from LPN-1 to the UE 18. The UE will measure CQI based on the P-CPICH and S-CPICH, respectively.

FIG. 6 shows a second example, which is similar to that shown in FIG. 5, i.e. LPN-1 transmits an S-CPICH, except that LPN-1 also transmits the same P-CPICH as the other nodes, i.e. macro node, LPN-2 and LPN-3. Thus, the channel experienced by P-CPICH includes the paths from the macro node, LPN-1, LPN-2 and LPN-3 to the UE 18. This gives a higher probability that the CQI associated with the channel experienced by P-CPICH will be higher from the perspective of the MIMO-capable UE 18.

As explained above, each of the modes provides gains under different deployment scenarios. For example, the SFN mode performs better under low load conditions and provides coverage. The node selection with spatial re-use mode performs better when the load of the cell is high. It is noted that all the UE categories as defined in the 3GPP standard will benefit with these modes. However, it is considered that Release-7 or MIMO capable UEs may benefit from additional operation modes.

In particular, for MIMO capable UEs, there are a number of ways to enable spatial reuse by utilizing existing or new MIMO operations. In principle, the multiple transmit antennas used by a MIMO transmitter may be arranged within a network node of a heterogeneous mobile communications network or distributed to different locations, i.e. distributed across multiple nodes in the heterogeneous mobile communications network, such as the macro base station 4 and the low power base station 8, or two low power base stations.

However, in a network also including mobile devices incapable of receiving MIMO transmission, an extensive deployment of multiple transmit antennas causes interference to the legacy mobile devices. As an effect, increasing the pilot power on a 2^{nd} antenna reduces cell throughput, hence the mean throughput for legacy mobile devices.

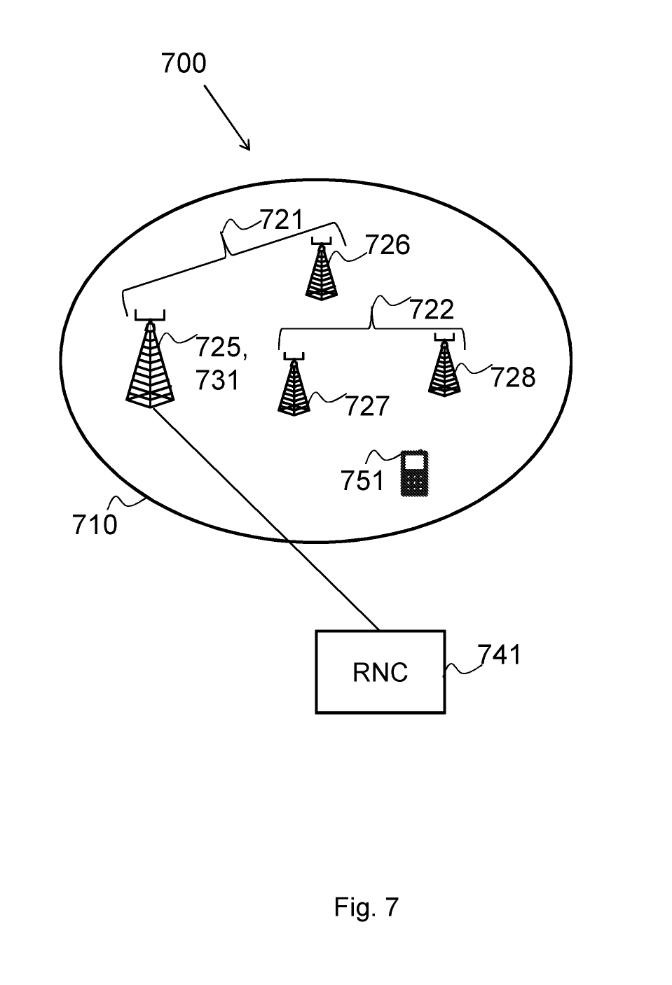

FIG. 7 depicts a heterogeneous mobile communication network 700, which may be an UMTS network or an LTE network, in which embodiments herein may be implemented.

The heterogeneous mobile communication network 700 comprises base station nodes, sharing a cell identity and being deployed within a coverage area 710. The coverage area may for example correspond to a cell associated to a macro node.

In some embodiments the heterogeneous mobile communication network 700 comprises a first set of base station nodes 721 selected to operate in a non-MIMO mode and a second set of base station nodes 722 selected to operate in a MIMO mode. At least one of the base station nodes comprised in the first and second sets of base stations 721, 722 may be a macrocell base station, such as the macrocell base station 725, and several of the base station nodes comprised in the first and second sets of base stations 721, 722 may be low power nodes, such as the low power nodes 726, 727, 728, which for example may be femtocell base stations. The base station nodes may each be a radio base station such as e.g. a NodeB or an eNB or an e-NodeB or any other network node capable to serve a user equipment in a heterogeneous mobile communication network.

The heterogeneous mobile communication network 700 further comprises a network node 731. The network node 731 may comprise a central scheduler, which central scheduler is not shown in FIG. 1. The network node 731 may be macrocell base station, such as a NodeB or an eNB or any other network node capable to serve a user equipment in a heterogeneous mobile communication network. However, other embodiments where the network node 731 is a low power node are also envisioned.

The network node 731 communicates with a radio network controller 741, which controls the base station nodes and manages radio resources and mobility in the coverage area 710. The radio network controller 741 may for example be an RNC in an UMTS network. The radio network controller 741 may also communicate with the base stations, for example via high speed optical cable or the Internet The radio network controller 741 may also connect the base stations to higher parts of the network, such as a Core Network not shown in FIG. 1. In LTE the radio network controller 741 and the network node 731 are combined in an e-Node B.

The radio network controller 741 further communicates with one or more mobile devices 751 located in the coverage area 710. The mobile device 751 may be a UE. The mobile device 751 may further communicate wirelessly with one or more of the base station nodes in the heterogeneous mobile communication network 700. For example the mobile device 751 may communicate with one of the base stations in the second set of base station nodes 722. Further the mobile device 751 is capable of MIMO operation.

The heterogeneous mobile communication network 700 may further comprise mobile devices not capable of MIMO operation, also referred to as a legacy mobile devices, which are not shown in FIG. 7.

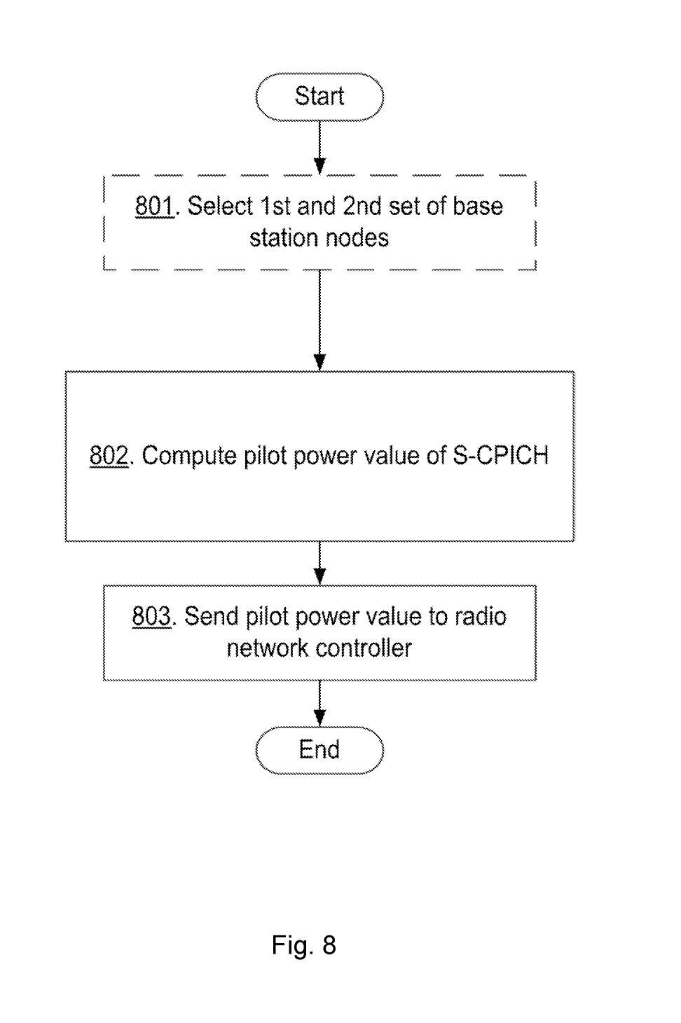

FIG. 8 is a flow chart of a method embodiment performed in the network node 731 in the heterogeneous mobile communications network 700 disclosed in FIG. 7. The method comprises actions for sending a pilot power value, which actions may be taken in any suitable order.

The network node 731 wherein the method embodiment according to the flow chart of FIG. 8 is performed may be a central scheduler node within a coverage area of the first set of base station nodes 721 selected to operate in a non-MIMO mode and a second set of base station nodes 722 selected to operate in a MIMO-mode. The base station nodes of said first and second set of base station nodes share a cell identity.

Action 801

In order to avoid interference from the secondary pilot channels to the legacy mobile devices, MIMO may be deployed in a subset of base station nodes only. Thus, in some embodiments the network node 731 selects the first set of base station nodes 721 to operate in a non-MIMO, mode and selects the second set of base station nodes 722 to operate in a MIMO-mode. In this case the mobile device 751, which is capable of MIMO operation, may measure the CQIs associated with P-CPICHs transmitted from the base station nodes in the first set and the second set of base station nodes 21, 722, and S-CPICHs transmitted from the base station nodes in the second set of base station nodes 722. In this way the legacy mobile devices, which may receive P-CPICHs from the first set of base station nodes 721, are not interfered by the secondary pilot channels of the second set of base station nodes 722.

Action 802

The network node 731 computes a pilot power value. The pilot power value is to be applicable when the one or more mobile devices 751 in the coverage area 710 evaluates receipt of one or more Secondary Common Pilot Channels, S-CPICH, from a transmitter in said second set of base station nodes 722. In other words the pilot power value is applicable for a subsequent evaluation of the S-CPICH in a mobile device, such as the mobile device 751.

The computing is based on a measure indicative of a transmission power of the second set of base stations 722. The computing will be explained below.

The pilot power value may be computed as a pilot power offset value. In some embodiments the pilot power offset value represents an offset value between a transmission power for the one or more S-CPICHs and a transmission power for a Primary Common Pilot CHannels, P-CPICH.

Computing the pilot power offset value may comprise:
determining a first measure indicative of a transmission power of the first set of base stations;
determining a second measure indicative of a transmission power of the second set of base stations; and
determining a relationship between the first measure and the second measure and applying this relationship to a prior pilot power offset value.

The prior pilot power offset value may be a pilot power offset value determined for a homogeneous network. The homogeneous network may correspond to the heterogeneous mobile communications network without any additional low power nodes.

In some embodiments the first measure represents the sum of transmission powers for every base station node in the first set of base station nodes 721 and the second measure represents the sum of transmission powers for every base station node in the second set of base station nodes 722.

In some embodiments the pilot power offset is computed according to the following: Presuming n nodes, such as the base station nodes 725, 726, where only the P-CPICH is transmitted and m nodes, such as the base station nodes 727, 728, where both the P-CPICH and the S-CPICH are transmitted. P1, P2 . . . Pn are the transmission powers of the nodes, such as the base station nodes 725, 726, where P-CPICH is only transmitted and Q1, Q2, . . . Qm are the transmission powers of nodes, such as the base station nodes 727, 728, from where both the P-CPICH and the S-CPICH are transmitted.

Then the pilot power offset is computed as:

$$NewOffset = HomogeneousOffset * {\sum }_{j = 1}^{m} Qj \div {\sum }_{i = 1}^{n} Pi$$

Thus the computed pilot power offset may be a fraction of the value of the transmission power of the S-CPICH for a homogeneous network. The pilot power offset may be sent to the radio network controller 741, which may be an RNC, as a fraction or as an actual value of the pilot power offset.

Action 803

When a pilot power value has been computed in the network node 731, information indicative of this pilot power value is sent to the radio network controller 741, which may be an RNC. The computed pilot power value is to be conveyed to one or mobile devices in the coverage area.

In other words, the network node 731 sends a information to the radio network controller 741. The information is indicative of the computed pilot power value. Sending the computed pilot power value to the network controller 741 will enable the one or more mobile devices 751 to be configured for MIMO operation.

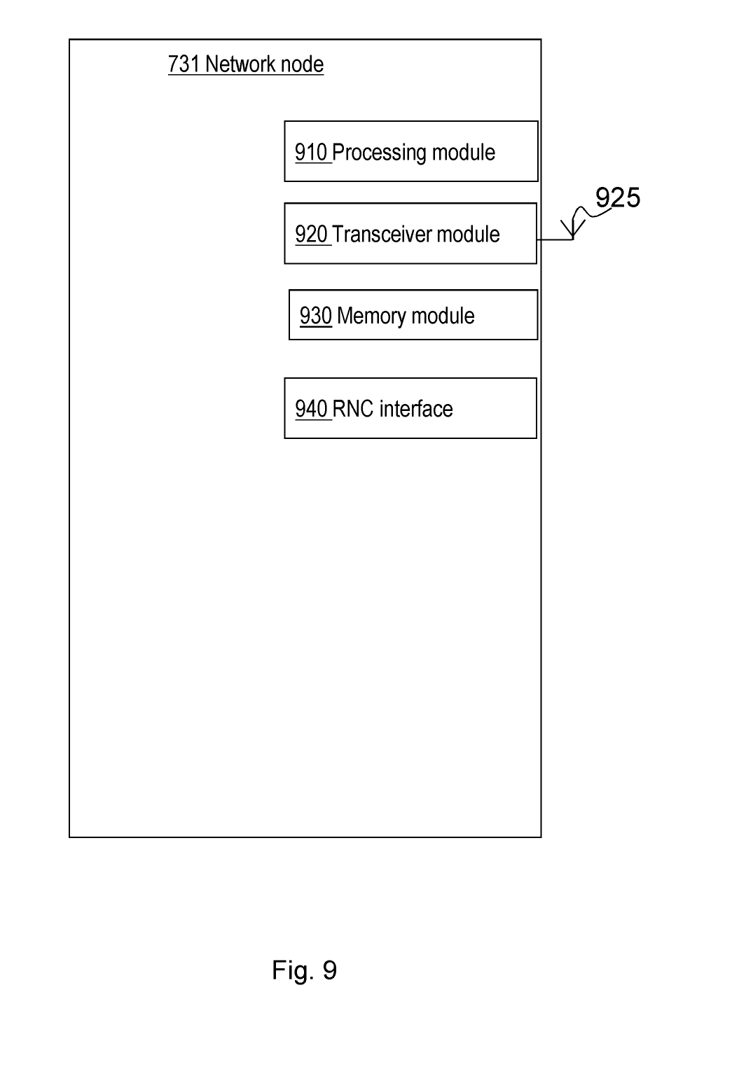

To perform the method actions for sending a pilot power value in the heterogeneous mobile communications network 700 described above in relation to FIG. 8, the network node 731, which may be connected to the central scheduler, comprises the following arrangement depicted in FIG. 9.

Although in practice a low power base station will not be identical in size and structure to a macrocell base station, for the purposes of this description, all the base stations are considered to comprise the same components.

Thus, the network node 731, which may be a base station, such as the base station 725, comprises a processing module 910 that controls the operation of the network node 731. The processing module may be comprised in a central scheduler. The processing module 910 is configured to compute a pilot power value to be applicable when the one or more mobile devices 751 in the coverage area 710 evaluates receipt of one or more S-CPICH from a transmitter in said second set of base station nodes 722. The computing is based on a measure indicative of a transmission power of the second set of base stations 722.

The processing module 910 is further configured to generate a information to a radio network controller 741, which information is indicative of the computed pilot power value. The computed pilot power value may be conveyed to one or mobile devices in the coverage area.

The processing module 910, which may be implemented with a single or multi-core processor, may be connected to a transceiver module 920 with one or more associated antennas 925. The transceiver module 920 and the one or more associated antennas 925 may be configured to transmit signals to, and receive signals from, user equipments, such as the mobile device 751, in the heterogeneous mobile communications network 700.

The network node 731, such as the base station 725, may further comprise a memory module 930, comprising one or more memory units. The memory module 930 may be connected to the processing module 910 and may store information and data required for the operation of the network node 731. The memory module 930 may be implemented with a random access memory (RAM), a read-only memory (ROM), a hard disk drive (HDD), and the like, The network node 731 also includes components and/or circuitry, such as an RNC interface 940 for allowing the network node 731 to exchange information with the radio network controller 741, which may be an RNC. The exchange of information with the radio network controller 741 may for example be performed via an Iub interface.

Computer program code may be necessary for performing the functions and actions of the embodiments herein. The program code mentioned above may also be provided as a computer program product, for instance in the form of a data carrier carrying computer program code for performing the embodiments herein when being loaded into the in the network node 731. One such carrier may be in the form of a CD ROM disc. It is however feasible with other data carriers such as a memory stick. The computer program code may furthermore be provided as pure program code on a server and downloaded to the network node 731.

Those skilled in the art will also appreciate that the processing module 910, the transceiver module 920, the memory module 930, and the RNC interface 940 described above may refer to a combination of analog and digital circuits, and/or one or more processors configured with software and/or firmware, e.g. stored in a memory, that when executed by the one or more processors perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

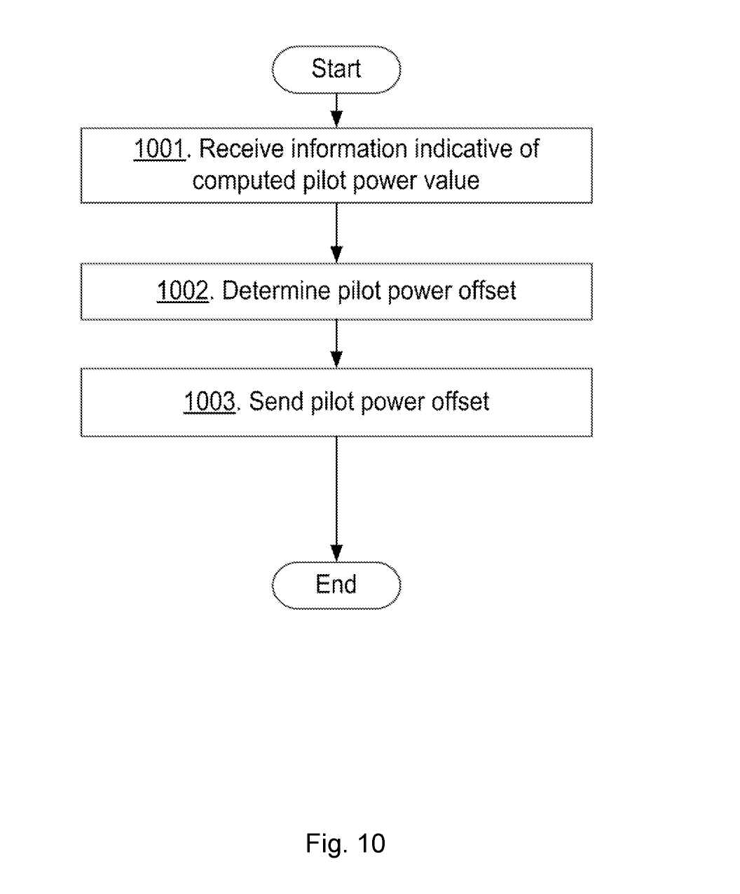

FIG. 10 is a flow chart of a method embodiment performed in the radio network controller 741 for enabling at least one mobile device 751 in configuring itself for MIMO operation in the heterogeneous mobile communications network 700. The radio network controller 741 may be an RNC.

As mentioned above, the heterogeneous mobile communication network 700 comprises base station nodes, such as the first and second set of base station nodes 721, 722, sharing a cell identity and being deployed within the coverage area 710. The heterogeneous mobile communications network 700 may comprise the first set of base station nodes 721 selected to operate in a non-MIMO mode and the second set of base station nodes 722 selected to operate in a MIMO mode.

The radio network controller 741 controls the base station nodes and manages radio resources and mobility in the coverage area 710. The radio network controller 741 may communicate with the network node 731.

Further, the mobile device 751 is located in the coverage area 710.

The method comprises the following actions, which actions may be taken in any suitable order.

Action 1001

The radio network controller 741 receives information from the network node 731. The information is indicative of a computed pilot power value. The computed pilot power value is applicable when evaluating receipt of one or more S-CPICH from a transmitter in said second set of base station nodes 722.

In some embodiments the received information comprises a computed pilot power offset value.

Action 1002

When the radio network controller 741 have received information from the network node 731, which may be connected to the central scheduler, indicating the computed pilot power value applicable for evaluating receipt of one or more secondary common pilot channels the radio network controller 741 determines a pilot power offset for the one or more S-CPICHs based on the received information.

Action 1003

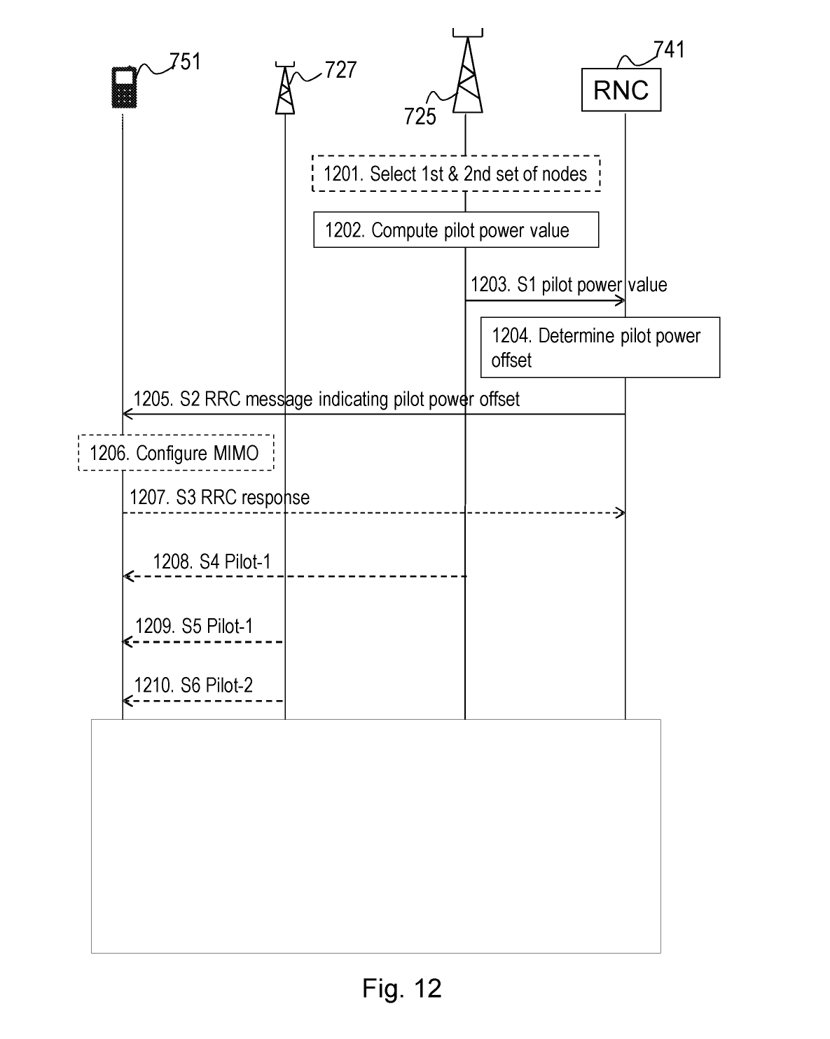

When the radio network controller 741 have computed the pilot power value applicable for evaluating receipt of the one or more secondary common pilot channels the radio network controller 741 sends a reconfiguration message, which may be an RNC reconfiguration message, to the affected mobile devices, which may be a UE. The reconfiguration message is denoted RRC message in FIG. 12. The reconfiguration message informs the affected mobile devices of configuration parameters required for MIMO operation. The configuration parameters may include any of an indication of the pilot codes used for S-CPICH, an indication of the power offset values and CQI power offset, an indication of the CQI report period, etc.

Thus, in this action the radio network controller 741 sends a signal to the at least one mobile device 751 within the coverage area. The signal comprises information indicative of said pilot power offset. By sending the signal the radio network controller 741 enables the at least one mobile device 751 in configuring itself for MIMO operation.

In some embodiments the information indicative of said pilot power offset further is indicative of a pilot power level for one or more P-CPICH.

The signal comprising information indicative of said pilot power offset may be comprised in an RRC message.

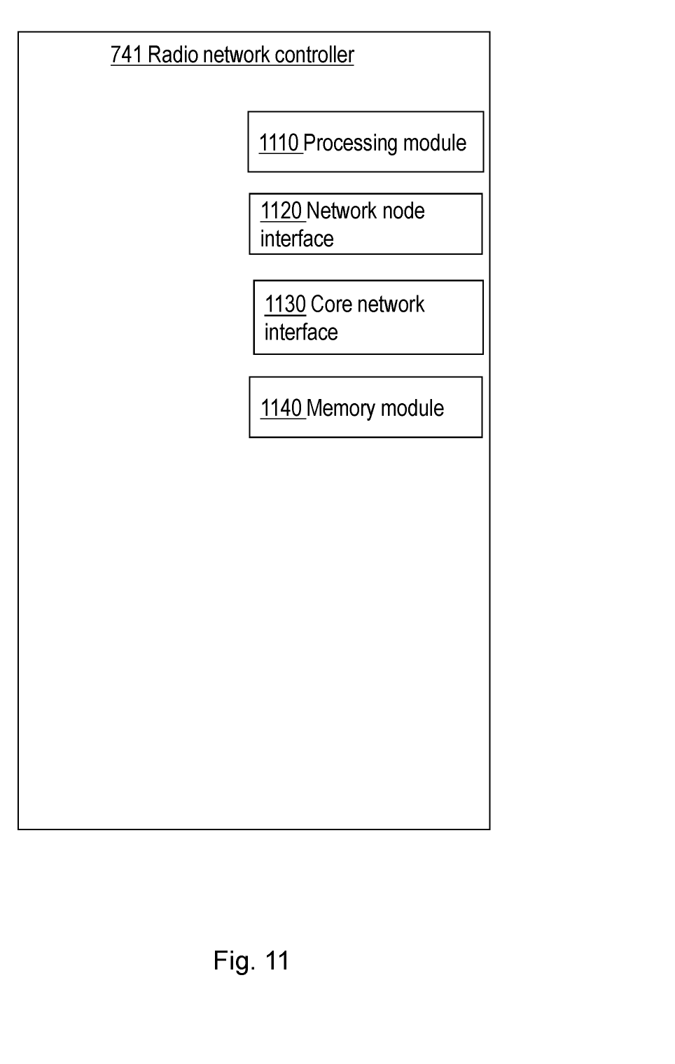

To perform the method actions for enabling at least one mobile device 751 in configuring itself for MIMO operation in the heterogeneous mobile communications network 700, described above in relation to FIG. 10, the radio network controller 741 comprises the following arrangement depicted in FIG. 11.

The radio network controller 741 comprises a processing module 1110, which may be implemented with a single or multi-core processor, that controls the operation of the radio network controller 741. The processing module 1210 is configured to receive information indicative of a computed pilot power value to be applicable when the one or more mobile devices 751 in the coverage area 710 evaluates receipt of one or more S-CPICH from a transmitter in said second set of base station nodes 722.

The processing module 1210 is further configured to determine a pilot power offset for the one or more S-CPICHs, based on the information.

The processing module 1210 is further configured to generate a signal to at least one mobile device 751 within the coverage area 710, which signal comprises information indicative of said pilot power offset.

The radio network controller 741 may further comprise a network node interface 1120 for interfacing with the network node 741. The network node interface 1120 allows the radio network node 741 to exchange information with the base stations with which it is associated, typically via the Iub interface.

The radio network controller 741 may further comprise a core network interface 1130 for exchanging information with the core network, typically via an Iu-CS and/or an Iu-PS interface.

The radio network controller 741 may also comprise a memory module 1140, comprising one or more memory units, which may be implemented with a random access memory (RAM), a read-only memory (ROM), a hard disk drive (HDD), and the like, that may store information and data required for the operation of the radio network controller 741.

The processing module 1110 may be connected to the network node interface 1120, to the core network interface 1130 and to the memory module 1140.

Computer program code may be necessary for performing the functions and actions of the embodiments herein. The program code mentioned above may also be provided as a computer program product, for instance in the form of a data carrier carrying computer program code for performing the embodiments herein when being loaded into the in the network node 731. One such carrier may be in the form of a CD ROM disc. It is however feasible with other data carriers such as a memory stick. The computer program code may furthermore be provided as pure program code on a server and downloaded to the network node 731.

Those skilled in the art will also appreciate that the processing module 1110, first interface 1120, second interface 1130, and memory module 1140 described above may refer to a combination of analog and digital circuits, and/or one or more processors configured with software and/or firmware, e.g. stored in a memory, that when executed by the one or more processors perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Actions for enabling at least one mobile device 751 in configuring itself for MIMO operation in the heterogeneous mobile communications network 700 will now be described with reference to FIG. 12. FIG. 12 discloses a message sequence chart for messaging between the radio network controller 741, e.g. an RNC, the macro base station 725 operating in a non-MIMO mode, a second low power node 727 operating in a MIMO-mode and the mobile device 751, e.g. an UE. The macro base station 725 and the low power node 727 share a cell identity, thus being part of a combined cell. The macro base station 725 comprises central scheduling capability, e.g. provided from a processing module in the macro base station 725 or through connection to a central scheduler.

Action 1201

Having the central scheduling capability, the macro base station 725 is configured to select the first set of base station nodes 721 to operate in a non-MIMO mode and the second set of base station nodes 722 to operate in a MIMO-mode. The first set of base station nodes 721 may then serve legacy mobile devices, i.e. mobile devices not capable of MIMO, while the second set of base station nodes 722 may serve mobile devices capable of MIMO. Thereby MIMO may be used in the combined cell with less interference for the mobile devices not capable of MIMO.

Action 1202

Having the central scheduling capability, the macro base station 725 node is configured to compute a pilot power value as previously described.

In other words the network node 731, such as the macro base station 725, computes a pilot power value to be applicable when one or more mobile devices 751 in the coverage area 710 evaluates receipt of one or more S-CPICHs from a transmitter in said second set of base station nodes 722. The computing is based on a measure indicative of a transmission power of the second set of base station nodes 722.

Action 1203

The computed pilot power value is signaled to the radio network controller 741 in a first message S1.

In other words, the network node 731 sends information to the radio network controller 741, which information is indicative of the computed pilot power value. This enables the one or more mobile devices 751 to be configured for MIMO operation.

Action 1204

When the radio network controller 741 has received the information from the network node (731), the radio network controller 741 determines a pilot power offset for the one or more S-CPICHs, based on the received information. In other words, the radio network controller 741 processes the message received from the macro base station node 725, and determines a pilot power offset.

Action 1205

The radio network controller 741 sends a signal to the at least one mobile device 751 within the coverage area, comprising information indicative of said pilot power offset. For example, an RRC message S2, is sent to the affected mobile devices, such as the mobile device 751, informing them of configuration parameters required for MIMO operation. The configuration parameters may include any of an indication of the pilot codes used for S-CPICH, an indication of the power offset values and CQI power offset, an indication of the CQI report period, etc.

Action 1206

When the at least one mobile device 751 has received the signal comprising information indicative of said pilot power offset, the at least one mobile device 751 configures itself for MIMO operation based on the received information indicative of said pilot power offset. For example, on receipt of the RRC message S2 from the radio network controller 741, the mobile device 751 reconfigures itself in accordance with the MIMO configuration parameters comprised in the RRC reconfiguration message.

Action 1207

The mobile device 751 then signals that the reconfiguration is complete by sending an RRC response S3 to the radio network controller 741.

Action 1208 and 1209

The mobile device 751 is then configured for MIMO operation and receives the Pilot 1 P-CPICH signal S4 transmitted by the macro base station 725 and the Pilot 1 P-CPICH signal S5 transmitted by the low power node 727.

Action 1210

The Pilot 2 S-CPICH secondary common pilot signal S6 is received from the low power node 727. The mobile device 751 is then capable of computing channel quality information, CQIs, for the channels from the disclosed macro base station node 725 and low power node 727 from measurements of the received P-CPICH and S-CPICH.

It will be appreciated that, for simplicity, only components of the network node 731 and the radio network controller 741 required to illustrate the methods described above are shown in the figures.

Embodiments herein provides a method in a network node, such as the network node 731 which is referred to as the network node below, for conveying pilot power information in a heterogeneous mobile communications network, such as the heterogeneous mobile communications network 700 also referred to as the heterogeneous mobile communications network below, comprising a first set of base station nodes, such as the first set of base station nodes 721 also referred to as the first set of base station nodes below, selected to operate in the non-MIMO mode and a second set of base station nodes, such as the second set of base station nodes 722 also referred to as the second set of base station nodes below, selected to operate in the MIMO-mode, the first and second set of base station nodes sharing a cell identity and being deployed within a coverage area, such as the coverage area 710 also referred to as the coverage area below. The method comprises computing of a pilot power value applicable when evaluating receipt of one or more secondary common pilot channels from transmitters in said second set of low power base station nodes. The computed pilot power value is signaled to a radio network controller, such as the radio network controller 741 also referred to as the radio network controller below. The radio network controller may be an RNC, for further conveying to one or more mobile devices, such as the on or more mobile devices 751 also referred to as the one or more mobile devices below, within the coverage area.

According to an aspect of embodiments herein, the pilot power value is computed as a pilot power offset value.

According to a further aspect of embodiments herein, the pilot power offset value represents an offset value between transmission power for the one or more secondary common pilot channels S-CPICH and transmission power for one or more primary common pilot channels, P-CPICH.

In accordance with a further aspect of embodiments herein, the first measure indicative of transmission power of the first set of low power base stations is determined. The second measure indicative of transmission power of the second set of low power base stations is also determined. The pilot power offset value is computed by determining the relationship between the first measure and the second measure and applying this relationship to the prior pilot power offset value, e.g. the pilot power offset value determined for a homogeneous network. In other words, the prior pilot power offset value may be the pilot power offset value applicable for MIMO-mode operation in the macrocell base station node according to an aspect of embodiments herein.

According to yet an aspect of embodiments herein, the first measure represents the sum of transmission powers for every base station node in the first set of low power base station nodes. The second measure represents the sum of transmission powers for every base station node in the second set of low power base station nodes.

Embodiments herein also relates to the network node, e.g. a NodeB, for use in the heterogeneous mobile communications network including the first set of base station nodes selected to operate in the non-MIMO mode and the second set of base station nodes selected to operate in the MIMO-mode, the first and second set of base station nodes sharing the cell identity and being deployed within the coverage area. The node comprises a processing module 910 configured to compute the pilot power value applicable when evaluating receipt of one or more secondary common pilot channels from transmitters in said second set of low power base station nodes and to generate the signal to the radio network controller, such as an RNC, including the computed pilot power value to be conveyed to one or mobile devices in the coverage area.

Embodiments herein further relates to a method in a radio network controller, such as an RNC, of the heterogeneous mobile communications network including the first set of base station nodes selected to operate in the non-MIMO mode and the second set of base station nodes selected to operate in the MIMO-mode, the first and second set of base station nodes sharing the cell identity and being deployed within the coverage area. The radio network controller receives information indicative of the computed pilot power value applicable when evaluating receipt of one or more secondary common pilot channels from transmitters in said second set of low power base station nodes. Following receipt of the information indicative of the pilot power value, the radio network controller determines the pilot power offset for one or more secondary common pilot channels, S-CPICH, based on the received information. The radio network controller sends the signal to at least one mobile device within the coverage area including information indicative of said pilot power offset.

According to an aspect of embodiments herein, information indicative of the pilot power level for one or more primary common pilot channels P-CPIPH is included in said signal to at least one mobile device. Said signal is preferably an RRC message, but may also be any other type of signal suitable for conveying pilot channel information to one or more mobile devices.

According to an aspect of embodiments herein, said information received in the radio network controller indicative of the computed pilot power value includes the computed pilot power offset value.

Embodiments herein also relate to the radio network controller, such as an RNC, in the heterogeneous mobile communications network including the first set of base station nodes selected to operate in the non-MIMO mode and the second set of base station nodes selected to operate in the MIMO-mode, the first and second set of base station nodes sharing the cell identity and being deployed within the coverage area. The radio network controller comprises a processing module 1110 configured to receive information indicative of the computed pilot power value applicable when evaluating receipt of one or more secondary common pilot channels from transmitters in said second set of low power base station nodes, to determine pilot power offset for one or more secondary common pilot channels, S-CPICH, based on the received information; and to generate the signal to at least one mobile device within the coverage area including information indicative of said pilot power offset.

Embodiments herein provide an improved way of configuring MIMO in the heterogeneous network whereby a subset of nodes within a coverage area, such as the coverage area 710, of a combined cell operate in the MIMO mode whilst the remaining nodes in the combined cell operate in the non-MIMO mode. Embodiments herein provide the benefits of maintaining coverage and spatial re-use gains that offered by the MIMO-mode, whilst limiting the drawbacks of increased interference experienced by legacy mobile devices.

Although embodiments described below refer to a UMTS mobile communications network, it will be appreciated that the teachings of embodiments herein are applicable to other types of network in which a heterogeneous arrangement of base stations may be used.

In addition, some embodiments described below refer to low power base stations, otherwise referred to herein as low power nodes or LPNs, within the coverage area of a macro base station, otherwise referred to herein as a macro node. However, it will be appreciated that the teachings of the embodiments herein are applicable to any type of heterogeneous deployment of nodes, e.g. a pico base station within the coverage area of a micro base station, a micro base station within the coverage area of a macro base station, or a femto base station within the coverage area of any of a picocell, microcell or macro base station.

In particular, it will be appreciated that the first set of nodes selected to operate in the non-MIMO mode may involve the macrocell base station as well as one or more low power nodes. Similarly, the second set of nodes selected to operate in the MIMO mode may involve the macrocell base station as well one or more low power nodes. Thus the teaching of the embodiments is not limited to low power nodes operating within the coverage area of the macrocell node and sharing the cell identity with the macrocell node.

Embodiments herein are particularly applicable when only a subset of nodes within a cell comprising a plurality of nodes as illustrated in FIG. 7 are configured for MIMO operation. When only a subset of nodes is configured in MIMO mode, the computation of pilot power on a second antenna is important as the power is signaled via RRC signaling to the UE, where it is used for estimating channel for data detection. In general in a homogeneous network, it is a common practice to use a predetermined pilot power offset, say 3 dB offset, compared to the P-CPICH power. However, since the P-CPICH is transmitted from all base station nodes merely informing −3 dB causes confusion to the mobile devices receiving the P-CPICH and S-CPICH. This is because all the base station nodes in the heterogeneous network do not transmit with the same power of the primary common pilot channel. For example, the real transmitted power from the second antenna may be offset by −13 dB of the power of a particular NodeB. Thus the homogeneous offset of −3 dB of combined P-CPICH is different than the real offset of −13 dB.

Embodiments described herein provide a method that enables the network node 731, which may comprise the central scheduler, in a combined cell to configure pilot signals to enable MIMO-mode operation. As described above, operating a combined cell in this mode enables MIMO gains to be achieved, and it is also possible to maintain the coverage and spatial re-use gains associated with the known modes of operation of combined cells.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting.

1-16. (canceled)

17. A method for enabling one or more mobile devices to be configured for Multiple Input Multiple Output (MIMO) operation by sending a pilot power value in a heterogeneous mobile communications network, the method being performed in a network node, the heterogeneous mobile communications network comprising a first set of base station nodes selected to operate in a non-MIMO mode, and a second set of base station nodes selected to operate in a MIMO mode, the first and the second set of base station nodes sharing a cell identity and being deployed within a coverage area, the method comprising:
computing a pilot power value to be applicable when one or more mobile devices in the coverage area evaluates receipt of one or more Secondary Common Pilot Channels (S-CPICH) from a transmitter in the second set of base station nodes, wherein the computing is based on a measure indicative of a transmission power of the second set of base station nodes, wherein the pilot power value is computed as a pilot power offset value;
wherein computing the pilot power offset value comprises:
determining a first measure indicative of a transmission power of the first set of base station nodes;
determining a second measure indicative of a transmission power of the second set of base station nodes; and
determining a relationship between the first measure and the second measure and applying this relationship to a prior pilot power offset value;
sending information to a radio network controller to be conveyed by the radio network controller to one or mobile devices in the coverage area, the information indicative of the computed pilot power value.

18. The method of claim 17, wherein the pilot power offset value represents an offset value between a transmission power for the one or more S-CPICHs and a transmission power for a Primary Common Pilot Channels (P-CPICH).

19. The method of claim 17, wherein the prior pilot power offset value is a pilot power offset value determined for a homogeneous network.

20. The method of claim 17, wherein:
the first measure represents the sum of transmission powers for every base station node in the first set of base station nodes; and
the second measure represents the sum of transmission powers for every base station node in the second set of base station nodes.

21. The method of claim 17, further comprising selecting the first set of base station nodes to operate in a non-MIMO mode and the second set of base station nodes to operate in a MIMO-mode.

22. A network node adapted to send a pilot power value in a heterogeneous mobile communications network, the heterogeneous mobile communications network comprising a first set of base station nodes selected to operate in a non-Multiple Input Multiple Output (MIMO) mode and a second set of base station nodes selected to operate in a MIMO-mode, the first and second set of base station nodes sharing a cell identity and being deployed within a coverage area, the network node comprising:
a processing circuit configured to compute a pilot power value to be applicable when one or more mobile devices in the coverage area evaluates receipt of one or more Secondary Common Pilot Channels (S-CPICH) from a transmitter in the second set of base station nodes, wherein the computing is based on a measure indicative of a transmission power of the second set of base station nodes, wherein the pilot power value is computed as a pilot power offset value;
wherein computing the pilot power offset value comprises:
determining a first measure indicative of a transmission power of the first set of base station nodes;
determining a second measure indicative of a transmission power of the second set of base station nodes; and
determining a relationship between the first measure and the second measure and applying this relationship to a prior pilot power offset value
circuitry configured to send information to a radio network controller, the information indicative of the computed pilot power value.

23. A method for enabling at least one mobile device in configuring itself for Multiple Input Multiple Output (MIMO) operation in a heterogeneous mobile communications network, the method being performed in a radio network controller, the heterogeneous mobile communications network comprising a first set of base station nodes selected to operate in a non-MIMO mode and a second set of base station nodes selected to operate in a MIMO mode, the first and the second set of base station nodes sharing a cell identity and being deployed within a coverage area, the method comprising:
receiving information from a network node, the information indicative of a computed pilot power value to be applicable when one or more mobile devices in the coverage area evaluates receipt of one or more Secondary Common Pilot Channels (S-CPICH) from a transmitter in the second set of base station nodes, wherein the received information comprises a computed pilot power offset value;
determining a pilot power offset for the one or more S-CPICHs based on the received information; and
enabling the at least one mobile device to configure itself for MIMO operation by sending a signal to the at least one mobile device within the coverage area, the signal comprising information indicative of the pilot power offset.

24. The method of claim 23, wherein the information indicative of the pilot power offset further is indicative of a pilot power level for one or more Primary Common Pilot Channels, P-CPICH.

25. The method of claim 23, wherein the signal comprising information indicative of the pilot power offset is comprised in a Radio Resource Control (RRC) message.

26. A radio network controller, adapted to operate in a heterogeneous mobile communications network comprising a first set of base station nodes selected to operate in a non-Multiple Input Multiple Output (MIMO) mode and a second set of base station nodes selected to operate in a MIMO mode, the first and second set of base station nodes sharing a cell identity and being deployed within a coverage area, the radio network controller comprising:
a processing circuit configured to:
receive information indicative of a computed pilot power value to be applicable when one or more mobile devices in the coverage area evaluates receipt of one or more Secondary Common Pilot Channels, (S-CPICHs) from a transmitter in the second set of base station nodes;
determine a pilot power offset for the one or more S-CPICHs based on the received information; and
generate a signal to at least one mobile device within the coverage area comprising information indicative of the pilot power offset.

27. A method for enabling at least one mobile device in configuring itself for Multiple Input Multiple Output (MIMO), the method being performed in a heterogeneous mobile communications network, the heterogeneous mobile communications network comprising a first set of base station nodes selected to operate in a non-MIMO mode and a second set of base station nodes selected to operate in a MIMO mode, the first and second set of base station nodes sharing a cell identity and being deployed within a coverage area, the method comprising:
computing, by a network node, a pilot power value to be applicable when one or more mobile devices in the coverage area evaluates receipt of one or more Secondary Common Pilot Channels (S-CPICH) from a transmitter in the second set of base station nodes, wherein the computing is based on a measure indicative of a transmission power of the second set of base station nodes, wherein the pilot power value is computed as a pilot power offset value, wherein the computing the pilot power offset value comprises:
determining a first measure indicative of a transmission power of the first set of base station nodes;
determining a second measure indicative of a transmission power of the second set of base station nodes; and
determining a relationship between the first measure and the second measure and applying this relationship to a prior pilot power offset value;
sending information from the network node to a radio network controller, the information indicative of the computed pilot power value, enabling the one or more mobile devices to be configured for MIMO operation;
receiving, in the radio network controller, the information from the network node, the information indicative of the computed pilot power value to be applicable when the one or more mobile devices in the coverage area evaluates receipt of the one or more S-CPICHs from the transmitter in the second set of base station nodes;
determining, by the radio network controller, a pilot power offset for the one or more S-CPICHs based on the received information;
sending a signal from the radio network controller to the at least one mobile device within the coverage area, the signal comprising information indicative of the pilot power offset;
receiving, in the at least one mobile device, the signal comprising information indicative of the pilot power offset; and
configuring the at least one mobile device for MIMO operation based on the received information indicative of the pilot power offset, wherein the configuring is done by the at least one mobile device itself.
